(19) United States
(12) Patent Application Publication
(10) Pub. No.: US 2022/0092528 A1
(43) Pub. Date: Mar. 24, 2022

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Toshiki KASHIWAKURA, Tokyo-to (JP); Osamu IZUMIDA, Nagoya-shi (JP); Xin JIN, Nagoya-shi (JP); Hideo HASEGAWA, Nagoya-shi (JP); Yoh IKEDA, Konan-shi (JP); Tomoya MAKINO, Kariya-shi (JP)

(73) Assignee: TOYOTA JIDOSHA KABUSHIKI KAISHA, Toyota-shi (JP)

(21) Appl. No.: 17/472,859

(22) Filed: Sep. 13, 2021

(30) Foreign Application Priority Data
Sep. 18, 2020 (JP) 2020-157174

(51) Int. Cl. G06Q 10/08; G10L 15/22; G10L 15/08; G06F 3/01; G06K 9/00

(52) U.S. Cl. CPC G06Q 10/0832; G06Q 10/0838; G06Q 10/087; G10L 2015/088; G10L 15/08; G06F 3/017; G06K 9/00335; G10L 15/22

(57) ABSTRACT

A controller of an information providing apparatus identifies, based on information input in the accommodation facility or the residential facility, an object, delivery of which is desired by the user. Furthermore, the controller outputs a provision request for the object. The provision request for the object includes delivery of the object to a place where the object is loaded onto an autonomous mobile body that is capable of transporting the object to an existing location of the user in the accommodation facility or the residential facility.

### CROSS REFERENCE TO THE RELATED APPLICATION

This application claims the benefit of Japanese Patent Application No. 2020-157174, filed on Sep. 18, 2020, which is hereby incorporated by reference herein in its entirety.

### BACKGROUND

### 1. Technical Field

The present disclosure relates to an information processing apparatus, an information processing method, and a non-transitory storage medium.

### 2. Description of the Related Art

Conventionally, there is a delivery system as follows. A first autonomous mobile body on which a second autonomous mobile body is loaded moves to a store. The second autonomous mobile body gets off at the store to move into the store, and pays for a product and loads the product. The second autonomous mobile body onto which the product is loaded gets on the first autonomous mobile body, and the first autonomous mobile body moves to a predetermined delivery place (for example, Japanese Patent Laid-Open No. 2019-128801).

### SUMMARY

The present disclosure is aimed at providing an information processing apparatus, an information processing method, and a non-transitory storage medium that facilitate reception of an object, delivery of which is desired by a user who is in an accommodation facility or a residential facility.

A mode of the present disclosure is an information processing apparatus including a controller configured to: identify, based on information input in an accommodation facility or a residential facility, an object, delivery of which is desired by a user; and output a provision request for the object, the provision request including delivery of the object to a place where the object is loaded onto an autonomous mobile body that is capable of transporting the object to an existing location of the user in the accommodation facility or the residential facility.

A mode of the present disclosure may include at least one of an information processing method, an information processing system, a program, and a recording medium recording the program that are provided with same characteristics as the information processing apparatus.

According to the present disclosure, reception of an object, delivery of which is desired by a user who is in an accommodation facility or a residential facility, may be facilitated.

### BRIEF DESCRIPTION OF THE DRAWINGS

FIG. 1 is a schematic diagram of an information processing system according to an embodiment;

FIG. 2 is a diagram illustrating an example configuration of a terminal;

FIG. 3 is a diagram illustrating an example configuration of a server;

FIG. 4 is a diagram illustrating an example data structure of a table;

FIG. 5 is a flowchart illustrating an example process by a terminal in a hotel;

FIG. 6 is a flowchart illustrating an example process by the terminal in the hotel;

FIG. 7 is a flowchart illustrating an example process by a server in the hotel;

FIG. 8 is a flowchart related to a server that manages a store and an order;

FIG. 9 is a flowchart illustrating an example process by a terminal in the store; and

FIG. 10 is a flowchart illustrating an example process by a terminal mounted on an autonomous mobile body.

### DESCRIPTION OF THE EMBODIMENTS

An information processing apparatus according to an embodiment includes a controller that performs the following.
(1) Identification, based on information input in an accommodation facility or a residential facility, of an object, delivery of which is desired by a user.
(2) Output of a provision request for the object, the provision request including delivery of the object to a place where the object is loaded onto an autonomous mobile body that is capable of transporting the object to an existing location of the user in the accommodation facility or the residential facility.

With the information processing apparatus, the controller identifies the object, delivery of which is desired by the user, based on information that is input in the accommodation facility or the residential facility. Then, the controller outputs the provision request for the object. In response to the provision request for the object, the object is delivered to a loading place of the object onto the autonomous mobile body, and the autonomous mobile body transports the object to the existing location of the user in the accommodation facility or the residential facility. The user may thus receive the object at his/her existing location without having to move to receive the object that is delivered to the accommodation facility or the residential facility. That is, the object can be easily received.

Here, the accommodation facility includes, but not limited to, a hotel, a condominium hotel, a campsite, a hospital, and a retreat. The residential facility includes, but not limited to, an apartment house (such as an apartment building). The object includes, but not limited to, a food and drink item, a household supply, and a medicine. The existing location of the user includes a room, and a building where the user is present.

The controller may identify the object based on information, in the information that is input, that is obtained by a sensor and that indicates speech/action of the user. That is, the provision request may be output by deriving the object desired by the user from the information indicating speech/action of the user. The sensor includes at least one of a microphone and a camera.

In the following, an information processing apparatus, an information processing method, and a program according to an embodiment will be described with reference to the drawings. The configuration of the embodiment is an example, and the present disclosure is not limited to the configuration of the embodiment.

<Configuration of Information Processing System>

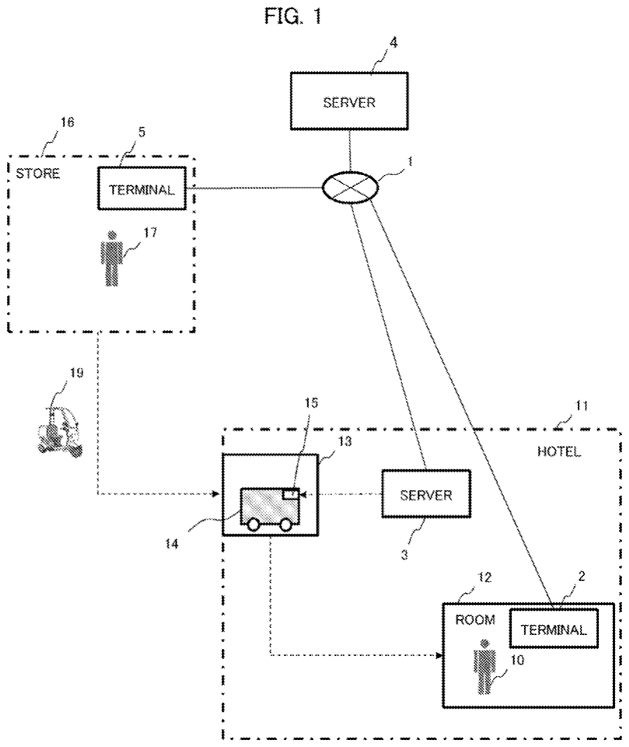

FIG. 1 is a schematic diagram of an information processing system according to the embodiment. In FIG. 1, the information processing system includes a terminal 2, a server 3, a server 4, and a terminal 5 that are each connected to a network 1.

For example, the network 1 is a public communication network such as the Internet, and a wide area network (WAN) or other communication networks may be adopted. The network 1 may also include a cellular network such as long term evolution (LTE) or 5G, and a wireless network (wireless routing) such as a wireless local area network (LAN: Wi-Fi included) and BLE.

A user 10 is a guest at a hotel 11 that is an example of the accommodation facility. The hotel 11 includes a plurality of rooms where guests are to stay, and the user 10 is staying in a room 12 among the plurality of rooms. The room 12 is an example of an “existing location of the user”.

The terminal 2 is installed in the room 12, and information indicating speech/action of the user 10 is input (the information is acquired). The terminal 2 is an example of an “information processing apparatus”. Additionally, the hotel 11 may instead be a residential facility such as an apartment house (such as an apartment building), and the room 12 may instead be a personal room (a residential area) of the user 10.

An autonomous mobile body 14 is provided in the hotel 11. The autonomous mobile body 14 is a small electric vehicle that performs autonomous driving. The autonomous mobile body 14 waits (is parked) at a standby place 13 provided inside the hotel 11, and is used to transport a delivered object to each room in the hotel 11.

A construction (a building) constructed as the hotel 11 includes a dedicated or general-purpose lift (elevator) that is used by the autonomous mobile body 14 to move between floors (floor levels), and the autonomous mobile body 14 is capable of moving between floors (floor levels) by using the lift. Alternatively, a slope may be provided in the construction to be used by the autonomous mobile body 14 to move between floors, or the autonomous mobile body 14 may move between floors using stairs. Furthermore, the building of the hotel 11 may be a one-storied building. Moreover, a movement mechanism provided on the autonomous mobile body 14 may be wheels, a caterpillar, or legs.

The server 3 is used to control operation of the autonomous mobile body 14. The autonomous mobile body 14 includes a terminal 15 that is capable of wirelessly communicating with the server 3, and the terminal 15 receives a command regarding movement from the server 3.

The server 4 is a server that manages, in a centralized manner, orders placed with a plurality of stores including a store 16, and the terminal 5 is used to notify a clerk 17 of an order that is placed with the store 16.

In the present embodiment, the store 16 is a store that sells and delivers food and drink items and cooked foods, and the terminal 5 displays a food and drink item according to an order, that is a desired object, and a delivery destination. The clerk 17 puts an ordered food and drink item on a motorbike 19 and delivers the same to the hotel 11.

The clerk 17 goes to the standby place 13 of the autonomous mobile body 14 in the hotel 11, and loads the food and drink item in a housing space of the autonomous mobile body 14. The standby place is an example of a “place where an object, delivery of which is desired, is loaded”.

The autonomous mobile body 14 starts moving when loading of a food and drink item (an object) is detected or the terminal 15 is operated (a movement start button is pressed, for example). An autonomous driving program to each room in the hotel 11 is installed in advance in the terminal 15 of the autonomous mobile body 14. The terminal 15 executes the autonomous driving program, and controls operation of a motor, an actuator and the like for autonomous driving, provided in the autonomous mobile body 14, such that the food and drink item is transported by the autonomous mobile body 14 to a room (the room 12) that is specified based on a command from the server 3. Additionally, after the user 10 takes out the food and drink item from the housing space of the autonomous mobile body 14, the autonomous mobile body 14 autonomously moves to the standby place 13 by execution of the autonomous driving program, and stops at the standby position.

<Configuration of Terminal>

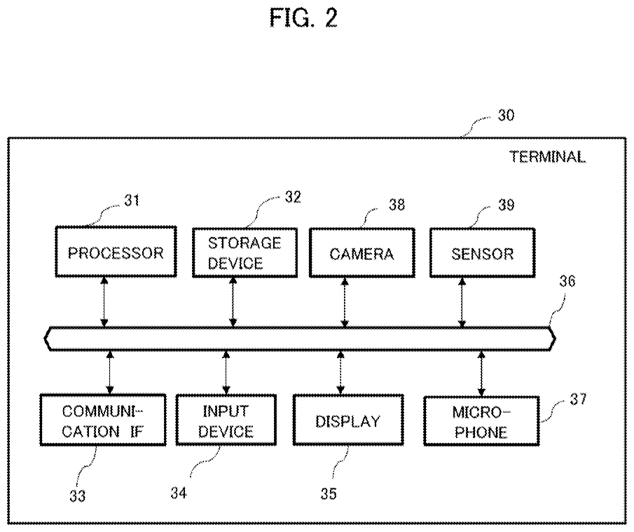

FIG. 2 illustrates an example configuration of a terminal 30 that can be used as the terminal 2, the terminal 5, and the terminal 15. As the terminal 30, general-purpose or dedicated fixed terminals including a PC and a WS, or dedicated or general-purpose mobile terminals (wireless terminals: terminals that are portable) including a wireless communication function may be used. The mobile terminal includes a smartphone, a tablet terminal, a laptop personal computer (PC), a personal digital assistant (PDA), and a wearable computer, for example.

In FIG. 2, the terminal 30 includes a processor 31 as a processing unit or a controller, a storage device (memory) 32, a communication interface (a communication IF) 33, an input device 34, a display 35, a microphone 37, a camera 38, and a sensor 39 that are interconnected via a bus 36. The microphone 37, the camera 38, and the sensor 39 are each an example of a “sensor”.

The memory 32 includes a main memory and an auxiliary memory. The main memory is used as a storage area for programs and data, a program development area, a program work area, a buffer area for communication data, and the like. The main memory includes a random access memory (RAM) or a combination of the RAM and a read only memory (ROM). The auxiliary memory is used as a storage area for data and programs. For example, as the auxiliary memory, a non-volatile storage medium such as a hard disk, a solid state drive (SSD), a flash memory, and an electrically erasable programmable read-only memory (EEPROM) may be used.

The communication IF 33 is a circuit that performs communication processing. For example, the communication IF 33 is a network interface card (NIC). Furthermore, the communication IF 33 may be a wireless communication circuit that performs wireless communication (such as LTE, 5G, wireless LAN (Wi-Fi), or BLE). Moreover, the communication IF 33 may include both a communication circuit that performs communication processing in a wired manner, and a wireless communication circuit.

The input device 34 includes keys, buttons, a pointing device, a touch panel and the like, and is used to input information. For example, the display 35 is a liquid crystal display, and the display 35 displays information and data. The microphone 37 is used to input an audio signal (audio information). The camera 38 is used to capture the user 10 in the room 12. The sensor 39 is a sensor, other than the microphone 37 and the camera 38, that detects information that indicates speech/action of the user.

The processor 31 is a central processing unit (CPU), for example. The processor 31 performs various processes by executing various programs stored in the memory 32.

<Configuration of Server>

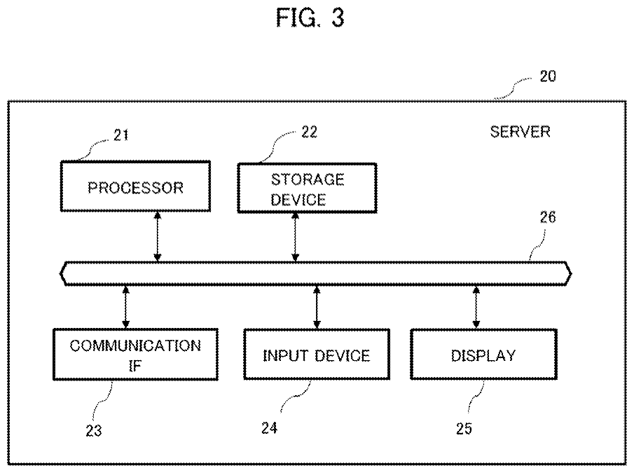

FIG. 3 illustrates an example configuration of a server 20 that is capable of operating as the server 3 and the server 4. The server 20 may be a general-purpose information processing apparatus (computer) such as a personal computer (PC) and a workstation, or a dedicated information processing apparatus such as a server machine. The server 20 includes a communication function, and is capable of connecting to the network 1 in a wired or wireless manner.

The server 20 includes a processor 21 as a processing unit or a controller, a storage device (memory) 22, a communication interface 23 (a communication IF 23), an input device 24, and a display 25 that are interconnected via a bus 26. The servers 3 and 4 may each be one information processing apparatus, or a collection (a cloud) of two or more information processing apparatuses.

As the processor 21, the memory 22, the communication IF 23, the input device 24, and the display 25, the same processor, memory, communication IF, input device, and display described as the processor 31, the memory 32, the communication IF 33, the input device 34, and the display 35 can be used, respectively. However, a processor, a memory, a communication IF, an input device, and a display with different performance from those adopted for the terminal 30 are used depending on differences in use, purpose of use and the like.

Additionally, a plurality of CPUs or a multicore CPU may be used as each of the processor 21 and the processor 31. At least a part of processes that are performed by the CPU may be performed by a processor other than the CPU, including a digital signal processor (DSP) and a graphical processing unit (GPU). Furthermore, at least a part of processes that are performed by the CPU may be performed by a dedicated or general-purpose integrated circuit (hardware) such as an application specific integrated circuit (ASIC) and a field programmable gate array (FPGA), or a combination of a processor and an integrated circuit. Such a combination is referred to as a microcontroller (MCU), a system-on-a-chip (SoC), a system LSI, or a chipset, for example.

<Details of Configuration of Terminal 2>

The processor 31 of the terminal 2 (the terminal 30 that operates as the terminal 2) performs, through execution of a program, a process of identifying an object, delivery of which is desired by the user 10, the object being input from at least one of the microphone 37, the camera 38, and the sensor 39. Furthermore, the processor 31 outputs, through execution of a program, a provision request for the object that is desired to be delivered. The provision request includes delivery of the object to the place (the standby place 13) where the object is loaded onto the autonomous mobile body 14 that is capable of transporting the object to the existing location (the room 12) of the user 10.

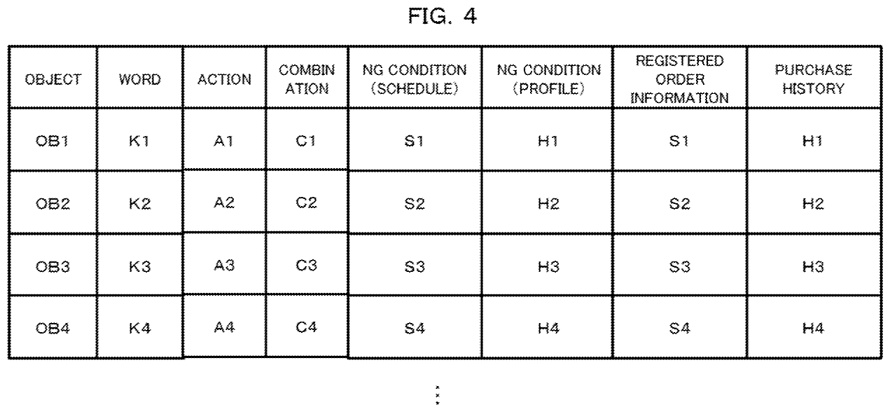

A table as illustrated in FIG. 4 is stored in the memory 32 of the terminal 2. The table includes one or more records (entries). The record is provided for each object that is desired by the user to be delivered.

The record includes information indicating the object that is desired by the user to be delivered, information indicating a word, information indicating an action, an NG condition related to a schedule, an NG condition related to a profile, registered order information, and information indicating a purchase history.

Here, the object here includes a food and drink item (including a cooked food), a household supply, a miscellaneous item, and a medicine. However, the object is not limited to those listed above so long as the object can be delivered and can be transported by the autonomous mobile body 14 (can be housed inside the housing space of the autonomous mobile body 14, for example). Furthermore, the object includes not only a sold item, but also a rental item. Food and drink items include pizza, Chinese wheat noodles, Japanese wheat noodles, Japanese buckwheat noodles, hamburgers, rice-bowl dishes, packed meals, alcoholic beverages (sake, distilled spirit, wine, beer, whiskey, etc.), non-alcoholic beverages (soda, tea, coffee, etc.) and the like.

The information indicating a word is an utterance or speech contents of the user 10 input from the microphone 37. The utterance or the speech contents possibly include a keyword for identifying the object, and the object may be identified by converting the utterance into text by speech recognition and by extracting, through morphological analysis or the like of the text, a keyword that is prepared in advance. A single word (for example, “pizza”) indicating an object, such as the name of the object, may be used as the keyword. Alternatively, a combination of a word indicating an object and a word expressing a wish regarding the object (for example, “pizza” and “I want to eat”) may be used as the keyword.

The information indicating an action is information that is captured by at least one of the camera 38 and the sensor 39 (that is input from at least one of the camera 38 and the sensor 39), and includes a captured image from the camera 38 and information that is detected by the sensor 39.

An action includes a gesture made by the user 10 of eating or drinking an object, and a motion of the user pointing at an image or a text indicating the object (for example, the user 10 pointing at a picture of pizza), for example. For example, a gesture of holding a beer mug and drinking indicates that beer is the object that is desired by the user 10 to be delivered (hereinafter referred to as a “desired object”). Alternatively, a gesture of turning a wine glass indicates that wine is the desired object. Alternatively, a gesture of holding a sake cup and drinking indicates that sake is the desired object. Alternatively, a gesture of holding a slice of pizza and lifting it to the mouth indicates that pizza is the desired object. Alternatively, a gesture of pinching and holding up noodles from a bowl indicates that Chinese wheat noodles, Japanese wheat noodles, or Japanese buckwheat noodles are the desired object. A gesture of using a household supply indicates that a household supply is the desired object.

Furthermore, the desired object may be identified from a combination of a word and an action, for example, a combination of an image in which a picture of a food and drink item is being pointed at, and words “I want to eat this”. Information about such a combination may also be included in the record in the table (see FIG. 4).

The NG condition related to a schedule indicates a schedule (a planned action) of the user 10 that indicates that intake or use of the desired object should be prohibited or avoided. For example, in relation to a desired object “alcoholic beverage”, driving of a vehicle is the NG condition.

Furthermore, the NG condition related to a profile indicates a profile (including personal information and an attribute) of the user 10 that indicates that intake or use of the desired object should be prohibited or avoided. For example, in the case where a desired object is an object on which an age restriction is imposed, such as alcoholic beverages and tobacco, the NG condition is that the age of the user 10 is lower than the age for which there are no restrictions. Alternatively, the NG condition is that the user 10 has a history of illness that prohibits intake of alcoholic beverages.

The registered order information includes information indicating the desired object for which an order for delivery is to be placed, an order destination, a delivery destination, and personal information (such as name, and contact information) of the user 10, and is registered in advance by the user 10 or the like. The registered order information is an example of “information, registered in advance, for ordering the object”.

Purchase history information is position information (uniform resource locator: URL) on a network where information indicating purchase and delivery of a desired object, used by the user 10 in the past, is recorded. In the case where there is no registered order information (order information is not registered), the desired object, the order destination, the delivery destination, and the personal information on the user 10 that are included in the past file of purchase and delivery are acquired using the URL, and order information may be generated using these information pieces.

<Example Process by Terminal 2>

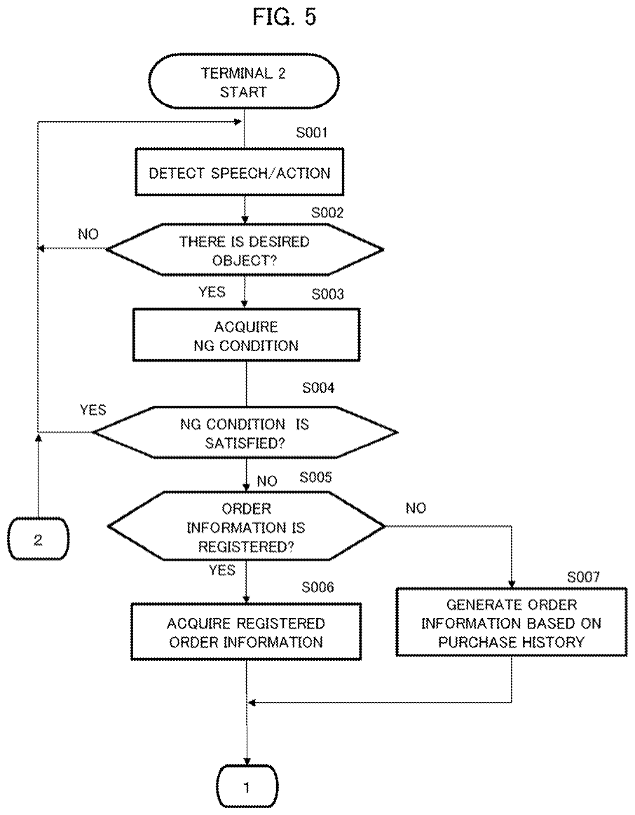

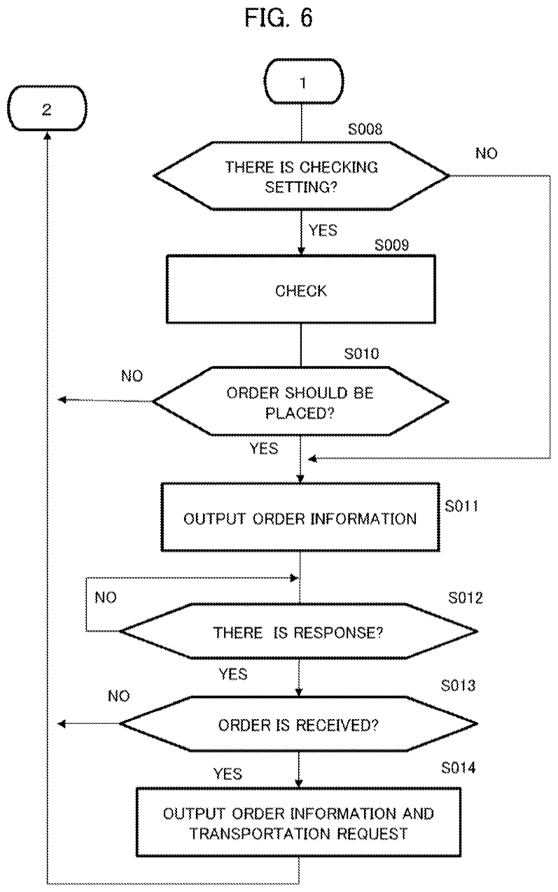

FIGS. 5 and 6 are flowcharts indicating example processes by the terminal 2. The processes illustrated in FIGS. 5 and 6 are performed by the processor 31 of the terminal 30 operating as the terminal 2.

In step S001, the processor 31 detects speech/action of the user 10 in the room 12. That is, information indicating the speech/action of the user 10 is acquired using at least one of the microphone 37, the camera 38, and the sensor 39 of the terminal 2. In step S002, the processor 31 determines whether a desired object is included in the speech/action.

For example, in the case where the microphone 37 is used, the processes in steps S001 and S002 are as follows. An audio signal of an utterance of the user 10 is collected by the microphone 37 and is A/D-converted by an A/D converter. The processor 31 performs a speech recognition process on the audio signal, acquires text information on the utterance, and stores the same in the memory 32.

The processor 31 performs a process such as morphological analysis in step S001, and determines presence/absence of a desired object based on whether a keyword registered in the table is included in the text information. In the case where the keyword is included in the text, the processor 31 identifies, as the desired object, an object that is associated with the keyword in the record where the keyword is included. At this time, the processor 31 determines in step S002 that there is an identified desired object, and the process proceeds to step S003. By contrast, in the case where the keyword is not included in the text information, it is determined in step S002 that there is no desired object, and the process returns to S001.

For example, in the case where the camera 38 is used for identification of an object, the processes in steps S001 and S002 are as follows. Image data (a video; a collection of still images) captured by the camera 38 is stored in the memory 32.

The processor 31 analyzes the image data in step S001, and determines whether a motion of the user 10 in the images matches an action that is registered in the table. Here, in the case where a gesture indicating intake or use of an object by the user 10 is included in the images, the processor 31 identifies, as the desired object, an object that is associated with the action in the record where the gesture (action) is registered. At this time, the processor 31 determines in step S002 that there is an identified desired object, and the process proceeds to step S003. In the case where the corresponding action is not included in the images, it is determined in step S002 that there is no desired object, and the process returns to S001. Instead of the gesture, the processor 31 may detect, in the images, an action of the user 10 of pointing at a picture or a text indicating the desired object. Additionally, a pose (a sign made with a hand or a leg) that is associated with a desired object may be detected as an action, instead of the gesture.

For example, in the case where the sensor 39 is used, the processes in steps S001 and S002 are as follows. The sensor 39 is a proximity sensor or a pressure sensor, for example, and is provided on a rear side of a picture (a photograph) of a plurality of food and drink items presented in the room 12. An output signal is output from the sensor 39 when the user 10 brings a finger close to the picture of any food and drink item or presses the picture (touches the picture) with a finger. An association table associating coordinates of a position that is close to or that is touched with a finger or the like and that is indicated by the output signal from the sensor 39, and a picture (a food and drink item) is stored in the memory 32.

When an output from the sensor 39 is received in step S001, the processor 31 identifies, using the association table, the food and drink item corresponding to the position coordinates detected by the sensor 39. The processor 31 determines in step S002 that there is an identified desired object, and the process proceeds to step S003. In the case where an object is not identified based on the position coordinates detected by the sensor 39, it is determined in step S002 that there is no desired object, and the process returns to S001.

In step S003, the processor 31 acquires the NG condition from the table. In step S004, the processor 31 determines whether the NG condition is satisfied.

In step S003, the processor 31 acquires schedule information on the user 10 from the memory 32 or a storage medium other than the memory 32. At this time, for example, in the case where the desired object is an alcoholic beverage, if the schedule information includes the plan for the user 10 to drive a vehicle within a specific period of time from a current time point, the processor 31 determines in step S004 that the NG condition is satisfied.

Alternatively, in step S003, the processor 31 acquires profile information on the user 10 from the memory 32 or a storage medium other than the memory 32. At this time, for example, in the case where the desired object is an alcoholic beverage, if the age of the user 10 included in the profile information is lower than the age at which intake of alcohol is allowed, the processor 31 determines in step S004 that the NG condition is satisfied.

At this time, in the case where the desired object is an alcoholic beverage for example, if the history of illness of the user 10 included in the profile information indicates that intake of alcohol is prohibited, the processor 31 determines in step S004 that the NG condition is satisfied. In the case where satisfaction of the NG condition is determined in step S004, the process returns to step S001; otherwise, the process proceeds to step S005. Determination of satisfaction of the NG condition described above is an example of determination that the order information is not to be output (transmitted), or in other words, that provision of the desired object is not necessary.

In step S005, the processor 31 determines whether the order information is registered in the table (the record for the identified object). In the case where it is determined that the order information is registered, the process proceeds to step S006; otherwise, the process proceeds to step S007.

In step S006, the processor 31 acquires the order information that is already registered in relation to the desired object from the record, and includes the number of the room 12 in the order information. Then, the process proceeds to step S008.

In the case where the process proceeds to step S007, the processor 31 generates the order information based on the purchase history. That is, the processor 31 accesses the past file of purchase and delivery using the purchase history information (URL of purchase history) stored in the table (record), and acquires information, included in the file, indicating the past purchase history of the desired object (that is, the desired object (purchased product), the order destination, the delivery destination, and the personal information on the user 10 are acquired). The processor 31 performs a standard task of editing the information indicating the past purchase history by, for example, changing the delivery destination to the address of the hotel 11 or by including the number of the room 12, and thus generates the current order information. Then, the process proceeds to step S008.

In step S008, the processor 31 determines whether there is a checking setting regarding an order, in relation to the user 10. The speech/action of the user 10 that is input to the terminal 2 may be performed by the user with the intention of ordering the desired object, or may simply be a wish of the user 10. For example, the user possibly utters “I want to eat pizza” or “I want to drink beer” without the intention of ordering. Automatic placement of an order in such a case may be not desirable for the user 10. Accordingly, the user 10 performs the checking setting on the terminal 2 in advance, in a case where the user does not wish an order to be placed without the user knowing it. The checking setting may be initially set to on. Whether the checking setting is set or not is stored in the memory 32 as flag on/off information that is referred to by the processor 31. The user 10 is able to operate on/off of the flag using the input device 34.

In step S008, the processor 31 refers to the flag of the checking setting, and determines whether the state of the flag is on. In the case where the flag of the checking setting is determined to be on, the process proceeds to step S009; otherwise (that is, in the case where the flag is determined to be off), the process proceeds to step S011.

In step S009, the processor 31 performs a checking process. For example, the processor 31 displays, on the display 35, contents of the order information and a check screen prompting input of necessity of placing the order. At this time, a sound calling attention to reference to the display 35 may also be optionally output to the user 10, together with display of the check screen.

The user 10 may refer to the check screen, and input the necessity of placing the order, using the input device 34. Input of the necessity of placing the order may be performed through audio input using the microphone 37. Additionally, instead of displaying the check screen, the processor 31 may output, from a speaker, contents of the order information and audio prompting a response regarding the necessity of placing the order.

In step S010, the processor 31 determines whether the response to the necessity of placing the order from the user 10 indicates that the order should be placed. At this time, in the case where the response is determined to indicate placement of the order, the process proceeds to step S011; otherwise, the process returns to step S001.

In step S011, the processor 31 outputs the order information. The order information is transmitted from the communication IF 33 to the server 4 over the network 1. In step S012, the processor 31 waits for reception of a response (a reply) indicating whether the order can be received, from the server 4. When a response is received, the process proceeds to step S013. The order information is an example of a “provision request for the object”.

In step S013, the processor 31 determines whether the response indicates reception of the order. At this time, in the case where the response is determined to indicate reception of the order, the process proceeds to step S014; otherwise (that is, in the case where it is determined that reception is not possible), the process returns to step S001.

In step S014, the processor 31 outputs the order information and a transportation request. The order information and the transportation request are transmitted to the server 3 over the network 1 or a network (such as a LAN) in the hotel 11. The transportation request is a request for transportation, by the autonomous mobile body 14, of the desired object that is ordered, and includes at least one of the number of the room 12 and information indicating the user 10. The response from the server 4 includes a delivery time (a scheduled arrival time at the hotel 11), and the delivery time is included in the transportation request. When step S014 is ended, the process returns to step S001.

With the processing by the terminal 2, when the user 10 utters “I want to eat XX (the name of the desired object)” in the room 12 in the hotel 11, with the intention of ordering pizza, for example, the voice is input to the terminal 2 through the microphone 37, and the processes illustrated in FIGS. 5 and 6 are performed. At this time, the processes illustrated in FIGS. 5 and 6 are performed also in the case of obscure speech “I wish I could eat XX” of the user 10. Accordingly, an operation that takes the feelings of the user 10 into consideration is performed (that is, an order is placed) even if there is no clear intention of the user 10.

In the case where the flag of the checking setting is on in the initial setting, or the user 10 positively sets the flag to on, the checking process in step S009 is performed, and the necessity of placing the order may be checked by the user 10. The user 10 may alternatively set the flag to off to make checking unnecessary so as to save trouble. Additionally, the processes in steps S008 to S010 are optional and may be omitted.

<Example Process by Server 3>

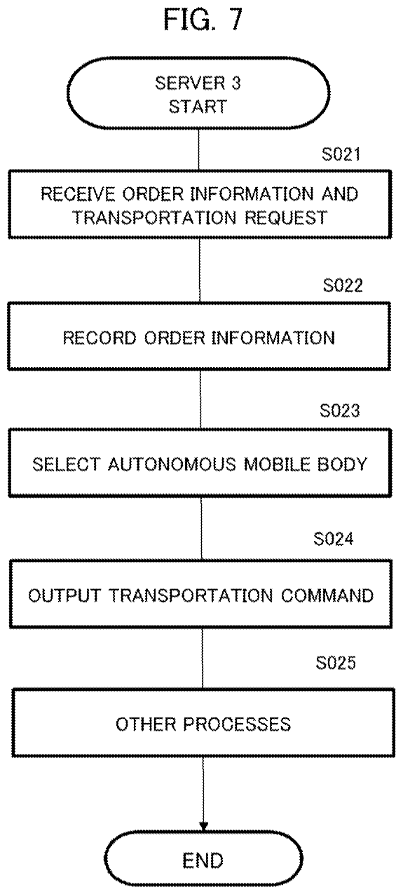

FIG. 7 is a flowchart illustrating an example process by the server 3. The process illustrated in FIG. 7 is performed by the processor 21 of the server 20 operating as the server 3. In step S021, the processor 21 receives, via the communication IF 23, the order information and the transportation request from the terminal 2.

In step S022, the processor 21 records the order information in the memory 22 (or other than the memory 22). In step S023, the processor 21 refers to management information for the autonomous mobile body 14 that is stored in the memory 22, and selects the autonomous mobile body 14 for transporting the desired object that is to be delivered based on the order information. The management information includes information indicating an operation state of each of a plurality of autonomous mobile bodies 14 in the hotel 11, and the processor 21 selects the autonomous mobile body 14 that can wait at the standby place 13 at the delivery time in the transportation request.

In step S024, the processor 21 outputs a transportation command for the terminal 15 of the autonomous mobile body 14 that is selected in step S023. The transportation command includes the order information and the number of the room 12 (a room number), and is received by the terminal 15 of the autonomous mobile body 14 that is selected, through wireless communication.

In step S025, other processes are performed. Other processes may include a process of transmitting, to the terminal 2, a notice indicating that the transportation request is received, and a process of charging a fee of transportation by the autonomous mobile body 14 to the user 10, for example. When the processes in step S026 are ended, the process in FIG. 7 is ended. Additionally, the processes in step S025 are optional and may be omitted. In this manner, the server 3 is used to manage operation of the autonomous mobile body 14, and to manage a guest (the user 10) of the hotel 11.

<Example Process by Server 4>

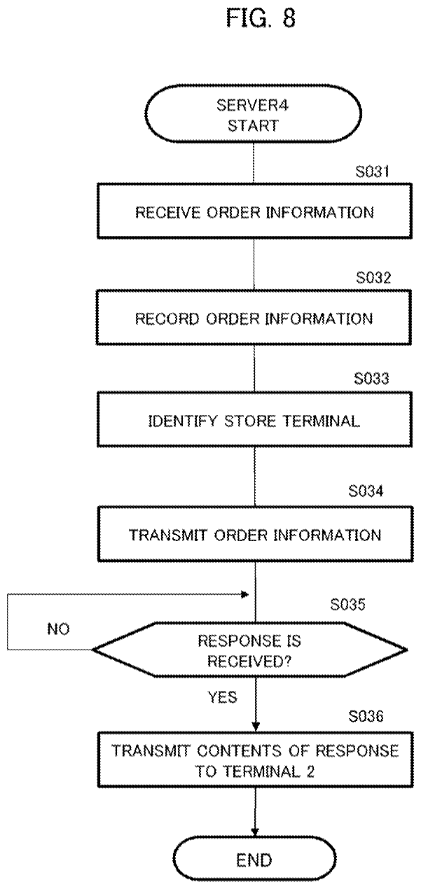

FIG. 8 is a flowchart illustrating an example process by the server 4. The server 4 manages, in a centralized manner, orders placed with a plurality of stores (including the store 16) that are capable of providing a desired object. The process illustrated in

FIG. 8 is performed by the processor 21 of the server 20 operating as the server 4.

In step S031, the processor 21 receives, via the communication IF 23, order information from the terminal 2. In step S032, the processor 21 records the order information in the memory 22 (or other than the memory 22).

In step S033, the processor 21 refers to a database of stores stored in the memory 22, and acquires a store (the store 16) corresponding to the information about the order destination included in the order information and a network address of the terminal 5 of the store 16.

In step S034, the processor 21 transmits the order information to the network address of the terminal 5. The order information is transmitted from the communication IF 23 to the terminal 5 over the network 1.

In step S035, the processor 21 waits for reception of a response (a reply) to the order information from the terminal 5, and in step S036, the processor 21 transmits contents of the received response to the terminal 2. In the case where the order is received by the store 16, the response includes a notice indicating that the order is received and a delivery time. In the case where the store 16 is not able to receive the order, the response includes a notice indicating that the order cannot be received.

In step S036, the processor 21 performs a process of transmitting contents of the response to the terminal 2. The terminal 2 thus receives the response via the communication IF 33, and processes from step S013 onward illustrated in FIG. 6 are performed.

<Example Process by Terminal 5>

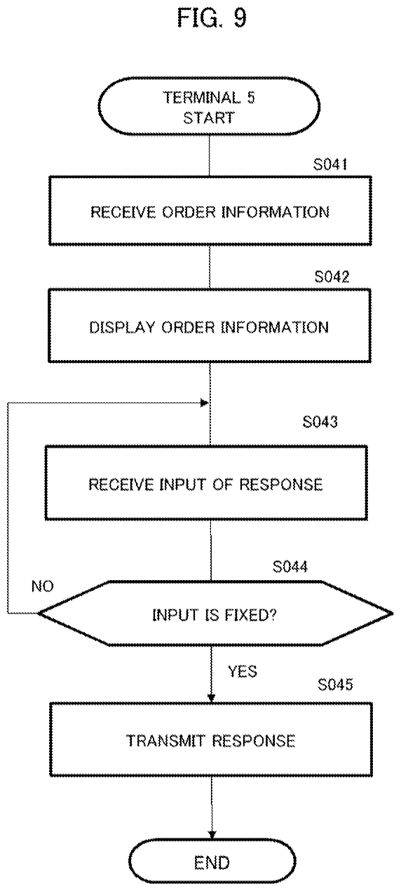

FIG. 9 is a flowchart illustrating an example process by the terminal 5. The terminal 5 is used as a terminal, in the store 16, for receiving an order, and is operated by the clerk 17 of the store 16. The process illustrated in FIG. 9 is performed by the processor 31 of the terminal 30 operating as the terminal 5.

In step S041, the processor 31 acquires order information from the server 4 that is received via the communication IF 33. In step S042, the processor 31 displays contents of the order information on the display 35. Accordingly, information, included in the order information, about the product as a target of order (the desired object), ordering person information (name and contact information on the user 10), the delivery destination (the address of the hotel 11, the number of the room 12), and the like are displayed on the display 35.

In step S043, the processor 31 receives a response to the order information that is input by the clerk 17 using the input device 34, and waits for end of input of the response (input indicating fixation) (step S044). In the case where end of input of the response is determined, the process proceeds to step S045.

In step S045, the processor 31 performs a process of transmitting the response to the server 4, and when the process in S045 is ended, the process in FIG. 9 is ended. The server 4 performs the process in step S036 with reception of the response as a trigger, and contents of the response are transmitted to the terminal 2.

When the order is received, the clerk of the store 16 prepares the product (a food and drink item: the desired object) that is the target of order. When the desired object is ready, the clerk (a delivery person) loads the desired object on the motorbike 19 for delivery, and performs delivery to the hotel 11. At the hotel 11, the delivery person is led to the standby place 13, and the desired object is loaded onto the autonomous mobile body 14 that is on standby at the standby place 13.

<Example Process by Terminal 15>

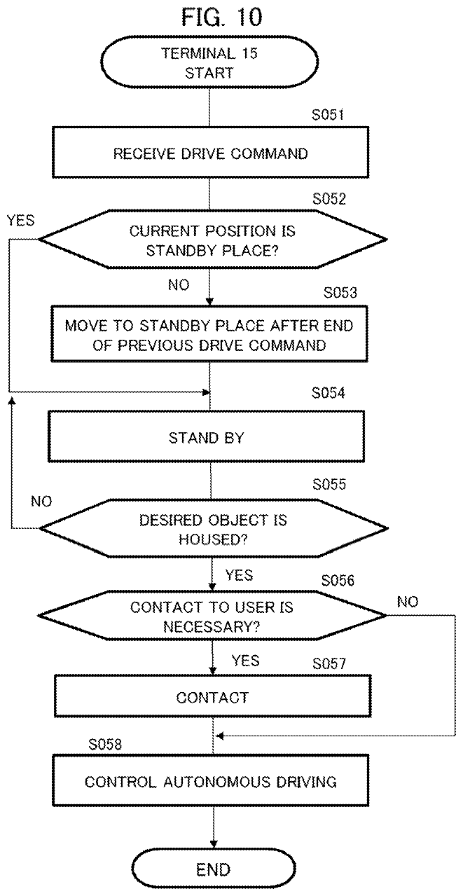

FIG. 10 is a flowchart illustrating an example process by the terminal 15. The process illustrated in FIG. 10 is performed by the processor 31 of the terminal 30 operating as the terminal 15.

In step S051, the processor 31 receives a drive command from the server 3. In step S052, the processor 31 determines whether the current position is the standby place 13. The processor 31 may determine whether the current position is the standby place 13 by comparing position information on the autonomous mobile body 14 that is detected by a GPS receiver of the autonomous mobile body 14 and position information on the standby place 13 that is stored in the memory 32.

In the case where the current position is determined to be the standby place 13, the process proceeds to step S054; otherwise, the process proceeds to step S053.

In the case where the process proceeds to step S053, the autonomous mobile body 14 is performing an operation that is based on a previous (preceding) drive command, and thus the autonomous mobile body 14 moves to the standby place 13 after ending the operation based on the preceding drive command. The processor 31 performs control regarding such movement. After arriving at the standby place 13, the autonomous mobile body 14 is parked at a predetermined position (a parking position) at the standby place 13, and is placed in a state of waiting for loading of a desired object.

In step S054, the processor 31 displays, on the display 35, the number of the room 12 included in the drive command. The delivery person may find, at the standby place 13, the autonomous mobile body 14 for loading the desired object, by using the number of the room 12 in the order information as a clue.

After finding the autonomous mobile body 14, the delivery person opens a lid of the housing space, places the desired object in the housing space, and closes the lid. The desired object is thus loaded on the autonomous mobile body 14. In step S055, the processor 31 receives a signal indicating open/close of the lid that is output from a sensor (such as a photosensor) provided on the autonomous mobile body 14 or from a switch that is switched on or off according to opening or closing of the lid, and determines completion of housing of the desired object.

In step S056, the processor 31 displays, on the display 35, an inquiry regarding whether contact to the user 10 is necessary or not, and waits for input of contact/non-contact. In the case where input indicating that contact is necessary is determined, the process proceeds to step S057; otherwise, the process proceeds to step S058.

In step S057, the processor 31 displays, as a contact process, a call button to the room 12, and when the call button to the room 12 is pressed, a call is made to a housephone in the room 12 using an intercom function of the autonomous mobile body 14. When the user 10 performs an answering process with the housephone, a line is connected, and the delivery person may talk with the user 10 over the intercom using a housephone (a microphone, a speaker and the like) of the autonomous mobile body 14. The user 10 may thus be notified of delivery of the desired object and completion of loading on the autonomous mobile body 14. At this time, the user 10 may give the delivery person a message to the store 16.

The process in step S058 is started in the case where contact is determined to be not necessary in step S056 or in the case where communication over the intercom in step S057 is ended. In step S058, the processor 31 loads an autonomous driving program (stored in the memory 32) corresponding to the number of the room 12, and causes the autonomous mobile body 14 to start moving to the room 12. During movement, the processor 31 controls, as appropriate, operation of the motor and the actuator for autonomous driving that are provided in the autonomous mobile body 14.

When the autonomous mobile body 14 arrives in front of a door of the room 12, the processor 31 makes a call to the housephone in the room 12 using the intercom function of the autonomous mobile body 14, and notifies the user 10 of arrival of the autonomous mobile body 14. A doorbell of the room 12 may be pressed using a manipulator or the like of the autonomous mobile body 14. The user 10 opens the door of the room 12, opens the lid of the housing space of the autonomous mobile body 14, takes out the desired object, and closes the lid. The processor 31 assumes that closing of the lid indicates end of transportation of the desired object, and starts execution of an autonomous driving program for causing the autonomous mobile body 14 to move to the standby place 13.

### Effects of Embodiment

With the information processing system according to the embodiment, the processor 31 (the controller) of the terminal 2 (an example of the information processing apparatus) in the hotel 11 performs the following. That is, the processor 31 identifies, based on information input in the hotel 11 (the accommodation facility or the residential facility), the object, delivery of which is desired by the user 10. Furthermore, the processor 31 outputs (transmits) the provision request (the order information), for the desired object, including delivery (information about the delivery destination) of the desired object to a place (the standby place 13) where the desired object is loaded onto the autonomous mobile body 14 that is capable of transporting the desired object to the room 12 (the existing location of the user 10) in the hotel 11.

In the hotel 11 or an apartment house, a delivered object is often kept near an entrance of a facility, such as a reception desk (a lobby) of the hotel 11 or an entrance of the apartment house, from the standpoint of security and the like, and the user often has to go to the entrance for collection. According to the embodiment, the autonomous mobile body 14 transports the desired object to the room 12 of the user 10. Accordingly, the user 10 does not have to go to the reception desk or the lobby of the hotel 11 to receive the desired object. Reception of a desired object that is delivered is thus facilitated. Moreover, because the autonomous mobile body 14 moves to the room 12 by autonomous driving, a person is not required for transportation of the desired object to the room 12, and the burden on workers in the hotel 11 is not increased.

Furthermore, according to the embodiment, the processor 31 of the terminal 2 identifies the desired object based on information, in the information input to the terminal 2, that is obtained by a sensor (at least one of the microphone 37, the camera 38, and the sensor 39) and that indicates speech/action of the user 10. For example, the processor 31 identifies the desired object based on information, in the information that is input, that indicates a gesture made by the user 10 of taking in or using the desired object. Alternatively, the processor 31 identifies the desired object by extracting a word indicating the desired object, included in the speech of the user 10. In this manner, the order information may be output without the user 10 actively operating the terminal 2 to place an order.

Furthermore, according to the embodiment, the processor 31 of the terminal 2 generates the provision request (the order information) for the object by using information, registered in advance, for ordering the desired object or purchase history information related to the desired object. Accordingly, the order information may be generated even if the user 10 does not input information about the order.

Furthermore, according to the embodiment, the processor 31 of the terminal 2 determines whether the object should be provided or not, based on the schedule information on the user 10 or the profile information on the user 10. For example, the processor 31 of the terminal 2 makes a determination that provision of the desired object is not necessary (a determination that the NG condition is satisfied), in a case where intake or use of the object should be prohibited or avoided in relation to a future action included in the schedule information. Alternatively, the processor 31 of the terminal 2 makes a determination that provision of the desired object is not necessary (a determination that the NG condition is satisfied), in a case where an attribute of the user 10 included in the profile information indicates that intake or use of the desired object should be prohibited or avoided. In this manner, placement of an order for a desired object that is preferably not acquired according to the schedule of the user 10 or the profile of the user 10 may be avoided.

Furthermore, according to the embodiment, the processor 31 of the terminal 2 outputs a transportation request for transporting, using the autonomous mobile body 14, the desired object from a place where the desired object is loaded (the standby place 13) to the existing location (the room 12), in a case where the provision request (the order information) for the desired object is output. The autonomous mobile body 14 may thus be instructed to perform transportation.

<Modifications>

The embodiment illustrates an example where an order for the desired object is placed with the store 16 existing outside the hotel 11, but the store 16 may be present inside the hotel. Furthermore, the desired object may be ordered from room service of the hotel 11, and in this case, the order information may be transmitted to the server 3, in the hotel 11, that receives an order for room service, instead of the server 4.

Furthermore, an example where the accommodation or residential facility is the hotel 11 is illustrated, but the hotel 11 may instead be a residential facility such as an apartment house, or may instead be a recuperation facility such as a hospital where the user 10 is allowed to stay.

Furthermore, the terminal 2 and the server 3 may be implemented by one information processing apparatus (a computer). In other words, processes by the terminal 2 may be partially or wholly performed by the server 3. Moreover, the server 4 and the terminal 5 may be implemented by one apparatus. Alternatively, a configuration where the server 3 (or a combination of the terminal 2 and the server 3) directly communicates with the terminal 5 may also be adopted.

<Others>

The embodiment described above is merely examples, and the present disclosure may be changed as appropriate and implemented within the scope of the disclosure.

Furthermore, a process that is described to be performed by one apparatus may be shared and performed by a plurality of apparatuses. Alternatively, processes described to be performed by different apparatuses may be performed by one apparatus. Each function is to be implemented by which hardware configuration (server configuration) in a computer system may be flexibly changed.

The present disclosure may also be implemented by supplying computer programs for implementing the functions described in the embodiment described above to a computer, and by one or more processors of the computer reading out and executing the programs. Such computer programs may be provided to the computer by a non-transitory computer-readable storage medium that can be connected to a system bus of the computer, or may be provided to the computer via a network. The non-transitory computer-readable storage medium includes any type of disk including magnetic disks (floppy (R) disks, hard disk drives (HDDs), etc.) and optical disks (CD-ROMs, DVD discs, Blu-ray discs, etc.), for example. Furthermore, the non-transitory computer-readable medium includes read-only memories (ROMs), random access memories (RAMs), EPROMs, EEPROMs, magnetic cards, flash memories, optical cards, and any type of medium suitable for storing electronic instructions.

What is claimed is:

1. An information processing apparatus comprising a controller configured to:
identify, based on information input in an accommodation facility or a residential facility, an object, delivery of which is desired by a user; and
output a provision request for the object, the provision request including delivery of the object to a place where the object is loaded onto an autonomous mobile body that is capable of transporting the object to an existing location of the user in the accommodation facility or the residential facility.

2. The information processing apparatus according to claim 1, wherein the controller identifies the object based on information, in the information that is input, that is obtained by a sensor and that indicates speech/action of the user.

3. The information processing apparatus according to claim 2, wherein the controller identifies the object based on information, in the information that is input, that indicates a gesture made by the user of taking in or using the object.

4. The information processing apparatus according to claim 2, wherein the controller identifies the object by extracting a word indicating the object, included in speech of the user.

5. The information processing apparatus according to claim 1, wherein the controller generates the provision request for the object by using information, registered in advance, for ordering the object or purchase history information related to the object.

6. The information processing apparatus according to claim 1, wherein the controller determines whether the object should be provided or not, based on schedule information on the user.

7. The information processing apparatus according to claim 6, wherein the controller makes a determination that provision of the object is not necessary, in a case where intake or use of the object should be prohibited or avoided in relation to a future action included in the schedule information.

8. The information processing apparatus according to claim 1, wherein the controller determines whether the object should be provided or not, based on profile information on the user.

9. The information processing apparatus according to claim 8, wherein the controller makes a determination that provision of the object is not necessary, in a case where an attribute of the user included in the profile information indicates that intake or use of the object should be prohibited or avoided.

10. The information processing apparatus according to claim 1, wherein the controller outputs a transportation request for transporting, using the autonomous mobile body, the object from the place where the object is loaded to the existing location of the user, in a case where the provision request for the object is output.

11. An information processing method comprising:
identifying, by an information processing apparatus, based on information input in an accommodation facility or a residential facility, an object, delivery of which is desired by a user; and
outputting, by the information processing apparatus, a provision request for the object, the provision request including delivery of the object to a place where the object is loaded onto an autonomous mobile body that is capable of transporting the object to an existing location of the user in the accommodation facility or the residential facility.

12. The information processing method according to claim 11, wherein the information processing apparatus identifies the object based on information, in the information that is input, that is obtained by a sensor and that indicates speech/action of the user.

13. The information processing method according to claim 11, wherein the information processing apparatus generates the provision request for the object by using information, registered in advance, for ordering the object or purchase history information related to the object.

14. The information processing method according to claim 11, wherein the information processing apparatus determines whether the object should be provided or not, based on schedule information on the user.

15. The information processing method according to claim 11, wherein the information processing apparatus determines whether the object should be provided or not, based on profile information on the user.

16. The information processing method according to claim 11, wherein the information processing apparatus outputs a transportation request for transporting, using the autonomous mobile body, the object from the place where the object is loaded to the existing location of the user, in a case where the provision request for the object is output.

17. A non-transitory storage medium storing a program for causing a computer of an information processing apparatus to:
identify, based on information input in an accommodation facility or a residential facility, an object, delivery of which is desired by a user; and
output a provision request for the object, the provision request including delivery of the object to a place where the object is loaded onto an autonomous mobile body that is capable of transporting the object to an existing location of the user in the accommodation facility or the residential facility.

18. The non-transitory storage medium according to claim 17, wherein the program causes the computer to identify the object based on information, in the information that is input, that is obtained by a sensor and that indicates speech/action of the user.

19. The non-transitory storage medium according to claim 17, wherein the program causes the computer to determine whether the object should be provided or not, based on schedule information on the user.

20. The non-transitory storage medium according to claim 17, wherein the computer is caused to determine whether the object should be provided or not, based on profile information on the user.
